(19) United States
(12) Patent Application Publication
(10) Pub. No.: US 2016/0039554 A1
(43) Pub. Date: Feb. 11, 2016

(54) Brake Pad Kit Including an Absorbent Fabric Article

(71) Applicants: Robert Bosch LLC, Broadview, IL (US); Robert Bosch GmbH, Stuttgart, DE (US)

(72) Inventor: Juergen Bowe, Karlsruhe (DE)

(21) Appl. No.: 14/818,439

(22) Filed: Aug. 5, 2015

Related U.S. Application Data
(60) Provisional application No. 62/035,374, filed on Aug. 8, 2014.

(51) Int. Cl. B65B 61/22; F16D 65/092

(52) U.S. Cl. CPC B65B 61/22; F16D 65/092

(57) ABSTRACT

A brake pad kit includes a container enclosing an interior volume, a plurality of brake pads positioned in the interior volume, and an absorbent fabric article. The absorbent fabric article substantially surrounds each brake pad of the plurality of brake pads so as to separate each brake pad from the other brake pads and from the container.

### PRIORITY

This application claims the benefit of U.S. Provisional Patent Application No. 62/035,374 which was filed with the US. Patent and Trademark Office on Aug. 8, 2014, the disclosure of which is incorporated by reference herein in its entirety.

### TECHNICAL FIELD

This disclosure relates to shipping of products and more particularly to materials for protecting products during transport.

### BACKGROUND

Manufactured products are often shipped in containers that include packing materials, such as dunnage, to stabilize and protect the products within the container during transport. For products that include distinct pieces, or products that are shipped as groups or sets of components, the separate components may be bound together to prevent damage by intermittent contact between the components during transport.

Automotive brake pads are an example of a manufactured product with multiple components that can be bound together and shipped with packing materials in the container to minimize the risk of damage during transport. In some known brake pad packaging practices, the brake pads are bundled in groups of two or more pads and then shrink-wrapped in plastic before being placed in the container for transport. In other conventional brake pad packaging schemes, the brake pads are wrapped in brown paper, either individually or as a set, and then placed in the container. Another conventional approach to packaging brake pads includes positioning the individual pads between foam inserts that surround the spaced apart pads and prevent contact therebetween.

Existing product packaging systems typically suffer from the problem that the packing materials shipped with the manufactured product serve no related function once the product is delivered and removed from its container. For example, the plastic shrink wrap, the brown paper, or the foam inserts included as packaging with some brake pads is typically discarded immediately as waste since the material does not facilitate preparation or installation of the brake pads.

Consequently, there is a need for a packaging system that includes a packing material that not only serves to protect the manufactured product and container during transport, but that also functions to aid in the preparation or installation of the product after the product delivered.

### SUMMARY

In one embodiment, a brake pad kit comprises a container enclosing an interior volume, a plurality of brake pads positioned in the interior volume, and an absorbent fabric article. The absorbent fabric article substantially surrounds each brake pad of the plurality of brake pads so as to separate each brake pad from the other brake pads and from the container.

In one particular embodiment, the absorbent fabric article is 100% cotton. In another embodiment, the absorbent fabric article has a continuous rounded edge extending along a perimeter of the absorbent fabric article. In yet another embodiment, the absorbent fabric article has dimensions of approximately 12 inches by 13 inches.

In some embodiments, the brake pad kit further comprises at least one brake pad installation accessory, and the absorbent fabric article separates each brake pad from the brake pad installation accessory. In one embodiment, the at least one brake pad installation accessory includes at least one of a lubricant and a brake pad installation hardware kit. In another embodiment, the at least one brake pad installation accessory includes both a lubricant and a brake pad installation hardware kit.

In some embodiments of the brake pad kit the container is formed of a corrugated cardboard.

In a further embodiment of the brake pad kit, the absorbent fabric article is 1 oz. dyed.

In another embodiment, a method of packaging a plurality of brake pads comprises wrapping a plurality of brake pads with an absorbent fabric article so as to substantially surround each brake pad of the plurality of brake pads with the absorbent fabric article and placing the wrapped brake pads in an interior volume of a container.

In some embodiments, the method further comprises bunching the absorbent fabric article in areas of the container having large clearance between a respective brake pad of the plurality of brake pads and the container. In another embodiment, the method further comprises folding the absorbent fabric article in regions of the container having small clearance between a respective brake pad of the plurality of brake pads and the container.

In one embodiment of the method, the absorbent fabric article is 100% cotton.

In some embodiments, the method further comprises placing at least one brake pad installation accessory in the container in such a way that the at least one brake pad installation accessory is separated from the plurality of brake pads by the absorbent fabric article. In one embodiment of the method, the at least one brake pad installation accessory includes at least one of a synthetic lubricant and a brake pad installation hardware kit. In another embodiment, the at least one brake pad installation accessory includes both a synthetic lubricant and a brake pad installation hardware kit.

### BRIEF DESCRIPTION OF THE DRAWINGS

FIG. 1 is a perspective view of a pair of brake pads that are configured for connection to a brake caliper of an automobile.

FIG. 2 is a perspective view of a packaging system for transporting brake pads, such as the brake pads depicted in FIG. 1, with the packaging system including an absorbent fabric article configured to protect the brake pads within a container during transport.

FIG. 3 is a front view of the absorbent fabric article of FIG. 2 shown in a loosely opened position.

### DETAILED DESCRIPTION

For the purposes of promoting an understanding of the principles of the disclosure, reference will now be made to the embodiments illustrated in the drawings and described in the following written specification. It is understood that no limitation to the scope of the disclosure is thereby intended. It is further understood that the disclosure includes any alterations and modifications to the illustrated embodiments and includes further applications of the principles of the disclosure as would normally occur to one of ordinary skill in the art to which this disclosure pertains.

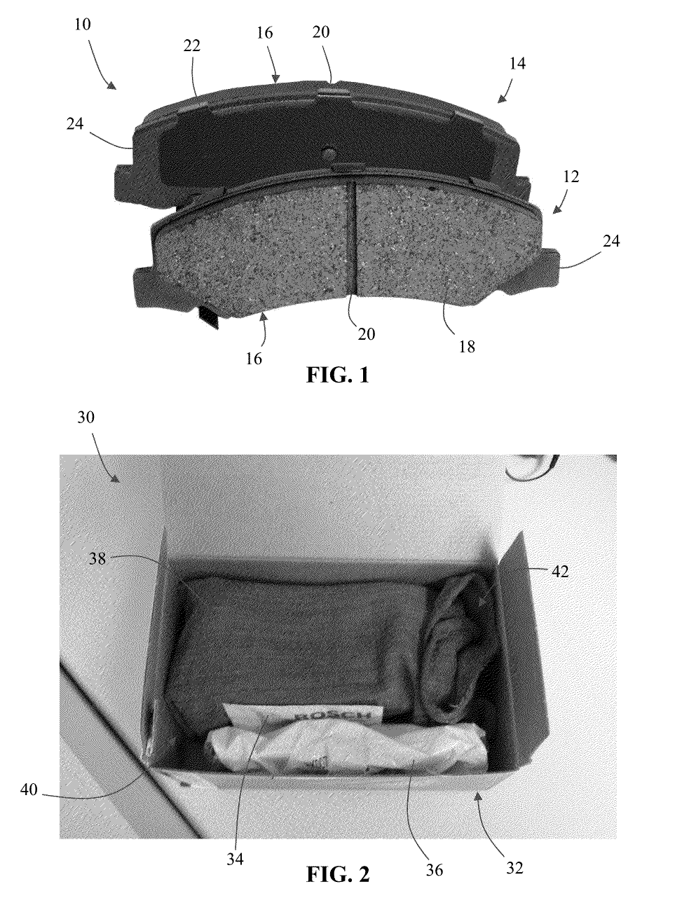

FIG. 1 depicts a pair of brake pads 10 that are configured to be attached to a brake caliper of an automobile. The pair of brake pads 10 includes a first brake pad 12 and a second brake pad 14, which in the embodiment shown are substantially similar. The brake pads 12, 14 each include friction material 16 that has at least one generally planar surface 18 configured to contact a brake rotor (not shown) of the automobile. The friction material 16 in the embodiment shown is formed from one of a non-asbestos organic (NAO) ceramic and a semi-metallic formula, although other friction material formulations can be used in other embodiments. One or more slots 20 are formed in the friction material 16 and may be positioned generally along any portion of the planar surface 18. The reader should appreciate that, in some embodiments, more than two brake pads are positioned in a single vessel or container 32 (as shown in FIG. 2).

The brake pads 12, 14 further include a rigid backing plate 22 connected to the friction material 16. The backing plate 22 is configured to support the friction material 16 under the high stresses generated during braking of the automobile. The backing plate 22 includes mounting features that enable the brake pads 12, 14 to be operatively connected to the brake caliper. A shim 24 is disposed between the friction material 16 and the backing plate 22 of the brake pads 12, 14. The shim in the embodiment shown is a multi-layer, laminated rubber-core shim that is molded to the friction material 16 and the backing plate 22. In other embodiments, the shim is composed of different materials and can be manually attached to the brake pads prior to assembly of the pads to the brake caliper. The shim 24 is configured to absorb sound vibrations that pass through the friction material 16 and the backing plate 22 due to the contact between the friction material 16 and the brake rotor during braking.

When the brake pads 12, 14 are transported from one location to another, care should be taken to ensure that the brake pads 12, 14 are not damaged due to contact with the shipping container or contact between the different components of the pads. In addition, the brake pads 12, 14 are in some instances shipped with tools or other hardware that could also damage the brake pads if the tools or hardware contact the brake pads during transport.

FIG. 2 depicts a packaging system 30 that is configured to stabilize and protect the brake pads 12, 14 during transport and to aid an installer in the preparation and installation of the brake pads 12, 14 after the brake pads are delivered. The packaging system 30 includes a container 32 sized to accommodate the brake pads entirely within a volume defined by walls of the container 32. In the embodiment shown, the container 32 is constructed from corrugated cardboard that is processed to form a substantially rectangular volume. In some embodiments, the container 32 is formed from another material. In further embodiments, the container 32 defines a volume having a different geometry, such as a square prismatic volume, a cylindrical volume, or a tubular volume.

One or more brake pads are placed in the container 32 for transport from one location to another. The container 32 in FIG. 2 includes two sets of brake pads, for example the pair of brake pads 10 of FIG. 1 and a second pair of brake pads, which, in some embodiments, are identical to the first set of brake pads. In one embodiment, the container 32 is sized to accommodate tools or other accessories in addition to the brake pads. In the embodiment of FIG. 2, for example, the container 32 includes a synthetic lubricant 34 and a hardware kit 36. In one embodiment, the brake pads 12, 14 in the container 32 are arranged such that the backing plates 22 of the brake pads are back-to-back. In another embodiment, the backing plate 22 of the first brake pad 12 faces the braking pad 16 of the second brake pad 14. In yet another embodiment, the backing plate 22 of the second brake pad 14 faces the braking pad 16 of the first brake pad 12. In alternate embodiment, the brake pads in the container 32 are placed in series or side by side.

The packaging system 30 further includes an absorbent fabric article 38 that substantially surrounds the brake pads in the container 32. As used herein, the term “substantially surrounds” is defined to require that the absorbent fabric article 38 surrounds at least 90% of the outer surface area of the brake pads. As shown in FIG. 2, the absorbent fabric article 38 loosely binds the brakes pads together to minimize relative movement between the pads during transport. The absorbent fabric article 38 also protects the brake pads from contact with the walls of the container 32, the lubricant 34, and the hardware kit 36 so as to reduce or prevent damage to the container or any of the contents within the container during transport. The absorbent fabric article 38 is configured to be creased and folded in portions, such as portion 40, to protect the brake pads in areas of relatively small clearance between the brake pads and the walls of the container 32. The absorbent fabric article 38 is also configured to be bunched in portions, such as portion 42, to occupy areas of relatively large clearance between the brake pads and the walls of the container 32 so as to minimize movement of the brake pads within the container 32.

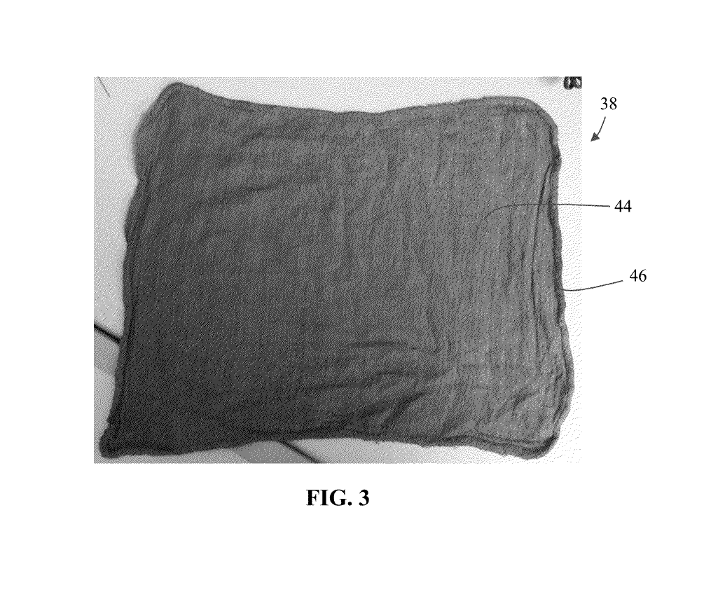

FIG. 3 shows the absorbent fabric article 38 in greater detail with the absorbent fabric article 38 loosely opened. The absorbent fabric article 38 in the embodiment shown is formed from 100% cotton natural material 44 and is rectangular with dimensions of approximately 12 inches by 13 inches. In some other embodiments, the absorbent fabric article 38 is formed from a lesser percentage of cotton natural material, while in still other embodiments, the absorbent fabric article 38 is formed entirely of different material or combinations of different materials. In some embodiments, the absorbent fabric article 38 is sized differently for various reasons, for example to accommodate more or fewer brake pads, to accommodate larger or smaller brake pads, and/or to occupy more or less space in the container 32.

As illustrated in FIG. 3, the absorbent fabric article 38 has a continuous rounded edge 46 that extends along its perimeter. The rounded edge is formed on the absorbent fabric article 38 to prevent the absorbent fabric article 38 from fraying at the edge. The absorbent fabric article 38 in the embodiment shown is one-ounce dyed with a blue dye, although in other embodiments the absorbent fabric article 38 need not be dyed or is dyed with more or less than one ounce of dye, and in other embodiments absorbent the fabric article 38 is dyed with a different color or multiple colors.

The absorbent fabric article 38 of the packaging system 30 has the advantage that it both protects the brake pad within the container 32 during transport and allows the installer to use the absorbent fabric article 38 for cleaning purposes during and after the installation of the same brake pads.

The absorbent fabric article 38 is configured to soak up liquids, such as water, grease, oil, and cleaning agents, and, in some instances, the absorbent fabric article 38 retains particulates such as dust and dirt. In various embodiments, the absorbent fabric article 38 is used during installation of the brake pads to clean various elements of the wheels on which the brake pads are installed, for example rotors, backing plates, calipers, lugnuts, retaining clips, and bolts. In some instances, the absorbent fabric article is used to wrap the used brake pads or to clean up excess lubricant, grease, dirt, or other waste products before, during, and after the installation of the brake pads. Since the absorbent fabric article is used for cleaning purposes, the use of additional absorbent fabrics in installation of the brake pads is reduced. As such, overall waste form the packaging and installation of the brake pads is reduced.

While the disclosure has been illustrated and described in detail in the drawings and foregoing description, the same should be considered as illustrative and not restrictive in character. It is understood that only the preferred embodiments have been presented and that all changes, modifications and further applications that come within the spirit of the disclosure are desired to be protected.

1. A brake pad kit comprising:
a container enclosing an interior volume;
a plurality of brake pads positioned in the interior volume; and
an absorbent fabric article substantially surrounding each brake pad of the plurality of brake pads so as to separate each brake pad from the other brake pads and from the container.

2. The brake pad kit of claim 1, wherein the absorbent fabric article is 100% cotton.

3. The brake pad kit of claim 1, wherein the absorbent fabric article has a continuous rounded edge extending along a perimeter of the absorbent fabric article.

4. The brake pad kit of claim 1, wherein the absorbent fabric article has dimensions of approximately 12 inches by 13 inches.

5. The brake pad kit of claim 1, further comprising:
at least one brake pad installation accessory,
wherein the absorbent fabric article separates each brake pad from the at least one brake pad installation accessory.

6. The brake pad kit of claim 5, wherein the at least one brake pad installation accessory includes at least one of a lubricant and a brake pad installation hardware kit.

7. The brake pad kit of claim 5, wherein the at least one brake pad installation accessory includes a lubricant and a brake pad installation hardware kit.

8. The brake pad kit of claim 1, wherein the container is formed of a corrugated cardboard.

9. The brake pad kit of claim 1, wherein the absorbent fabric article is 1 oz. dyed.

10. A method of packaging a plurality of brake pads comprising:
wrapping a plurality of brake pads with an absorbent fabric article so as to substantially surround each brake pad of the plurality of brake pads with the absorbent fabric article; and
placing the wrapped brake pads in an interior volume of a container.

11. The method of claim 10, further comprising:
bunching the absorbent fabric article in areas of the container having large clearance between a respective brake pad of the plurality of brake pads and the container.

12. The method of claim 10, further comprising:
folding the absorbent fabric article in regions of the container having small clearance between a respective brake pad of the plurality of brake pads and the container.

13. The method of claim 10, wherein the absorbent fabric article is 100% cotton.

14. The method of claim 10, further comprising:
placing at least one brake pad installation accessory in the container in such a way that the at least one brake pad installation accessory is separated from the plurality of brake pads by the absorbent fabric article.

15. The method of claim 14, wherein the at least one brake pad installation accessory includes at least one of a synthetic lubricant and a brake pad installation hardware kit.

16. The method of claim 14, wherein the at least one brake pad installation accessory includes a synthetic lubricant and a brake pad installation hardware kit.
